(19) United States
(12) Patent Application Publication
(10) Pub. No.: US 2025/0341810 A1
(43) Pub. Date: Nov. 6, 2025

(54) FEATURE PLACEMENT ERROR (FPE) METROLOGY AND CORRECTION

(71) Applicant: KLA Corporation, Milpitas, CA (US)

(72) Inventor: Jang Sun Kim, Gyeonggi-do (KR)

(21) Appl. No.: 18/896,205

(22) Filed: Sep. 25, 2024

Related U.S. Application Data
(60) Provisional application No. 63/641,446, filed on May 2, 2024.

(51) Int. Cl. G05B 13/04

(52) U.S. Cl. CPC G05B 13/041

(57) ABSTRACT

A system and method for measuring a sample is disclosed. The system may include a metrology sub-system and a controller. The controller may be communicatively coupled to the metrology sub-system and may include one or more processors. The processors may be configured to execute program instructions causing the processors to acquire one or more images of features of a sample, acquire sample design data corresponding to the features of the sample, and determine one or more feature placement error (FPE) measurements based on calculated areas of nonoverlap between shapes of the features in the one or more images and shapes of the features in the sample design data.

### CROSS-REFERENCE TO RELATED APPLICATION

The present application claims the benefit under 35 U.S.C. § 119(e) of U.S. Provisional Application Ser. No. 63/641,446, filed May 2, 2024, entitled PROCESS WINDOW ENLARGEMENT AND YIELD PREDICTION USING NOVEL FPE (FEATURE PLACEMENT ERROR) METROLOGY AND CORRECTION, naming Jang Sun Kim as inventor, which is incorporated herein by reference in the entirety.

### TECHNICAL FIELD

The present disclosure relates generally to semiconductor devices and, more particularly, to systems and methods for evaluating the error in fabrication of semiconductor devices.

### BACKGROUND

Metrology systems and methods are used to characterize semiconductor manufacturing processes. For example, overlay and critical dimension (CD) measurements may be performed to predict the performance and/or yield of a semiconductor manufacturing process.

In the semi-conductor manufacturing industry, extending process windows is increasingly important. As semiconductor processes become increasingly challenging, there is a growing demand for enhanced control over overlay and CD. Various methods have been proposed to overcome this, but actual manufacturing plants face many difficulties.

Edge placement error (EPE) is another metrology measurement based on overlay and CD. However, such metrology measurements are not necessarily a clear indicator of how much the actual electrical characteristics (e.g., electrical functionality) of a semiconductor wafer is being improved. Furthermore, even if the EPE is calculated, it may need to be recalculated from the scanner control perspective. To do this, there may be a difficulty in redefining the correlation between the bottom and top layers of the wafer. Real-time Advanced Process Control (APC) correction is not necessarily possible with EPE, making the potential of EPE limited as a yield improvement indicator in mass production.

Therefore, there is a desire for a system or method that addresses these shortfalls in semiconductor manufacturing processes.

### SUMMARY

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 illustrates a block diagram of a system for evaluating an error in fabrication of a sample, in accordance with one or more embodiments of the present disclosure.

FIG. 2A illustrates a diagram of overlay error and critical dimension (CD) error, in accordance with one or more embodiments of the present disclosure.

FIG. 2B illustrates a diagram of feature placement error (FPE), in accordance with one or more embodiments of the present disclosure.

FIG. 3 illustrates a diagram for performing FPE measurements, in accordance with one or more embodiments of the present disclosure.

FIG. 4 illustrates a flow diagram for performing FPE measurements including a metrology calibration parameter, in accordance with one or more embodiments of the present disclosure.

FIG. 5A illustrates a flow diagram 500 for performing FPE measurements in a fabrication system, in accordance with one or more embodiments of the present disclosure.

FIG. 5B illustrates a flow diagram for performing simulated FPE measurements, in accordance with one or more embodiments of the present disclosure.

FIG. 6 illustrates a flow diagram for monitoring a process budget, in accordance with one or more embodiments of the present disclosure.

FIG. 7 illustrates a flow diagram for generating simulated FPE measurements, in accordance with one or more embodiments of the present disclosure.

FIG. 8 illustrates a flow diagram for determining a key performance indicator, in accordance with one or more embodiments of the present disclosure.

FIG. 9 illustrates a process flow diagram depicting a method, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to determining feature placement error (FPE). FPE may be a measurement based on a two-dimensional (2D) area rather than a typical one-dimensional (1D) overlay or critical dimension (CD) measurement. In this way, in the FPE measurements of the present disclosure, the dimensionality is broadened from the traditional 1D overlay to a more comprehensive 2D measurement, encapsulating all relevant data such as overlay, cell overlay, CD, and critical dimension uniformity (CDU). The utilization of an after-develop-inspection-based metric enables effective Advanced Process Control (APC) correction. Moreover, through the deployment of data-to-database (D2DB) technology, in a sense, absolute matching from image to sample data such as Graphic Data System (GDS) is achieved.

The shift to two-dimensional data may provide augmented flexibility for scanner control, facilitating more accurate modifications and enhancements. Moreover, outcomes derived from the GDS empower the projection of yield over numerous layers of the sample. The capability to predict yield across multiple layers can result in more streamlined manufacturing processes and superior product quality.

In this way, embodiments of the present disclosure are directed to a system and method to widen process windows that allows for practical corrections in two-dimensions. For example, process margins may be improved in after-develop inspection (ADI) conditions. In embodiments, FPE may be based on an area of an imaged feature of a wafer that does not overlap with a rendered design polygon corresponding to the same feature. This nonoverlapping area may be used to determine the FPE, which can be used to predict yield and to optimize for wafer fabrication parameters such as offset, focus, dose, aberration, and/or the like.

Embodiments of the present disclosure may provide advantages in main domains such as, but not limited to, measurement and control. The FPE measurement data obtained from the ADI state may be processed through data-to-database (D:DB) to calculate optimal FPE values (e.g., X offset, Y offset, dose, focus, aberration). These calculated values may be used for optimizing the absolute sample design data during subsequent lot exposures. By providing feedback to the APC, the current measured lot can be adjusted to achieve the optimal FPE values for the next layer, thereby securing additional process window budget for overlay and CD. From a high-volume manufacturing perspective, the continuous adjustment of APC values allows the application of similar correction algorithms as in the existing APC method. Additionally, even in cases of sudden value increases, outlier removal can be achieved by adjusting parameters such as Lambda.

Embodiments of the present disclosure may be used to deliver an intuitive Key Performance Indicator (KPI). Typically, conventional EPE is computed based on the correlation between cells themselves, and between cells and lines. However, in embodiments, the FPE employs sample design data such as GDS, which may represent the absolute feature shape of the design, eliminating the need to identify the correlation between the bottom and top layers. In this way, the FPE may solely consider the ADI state of the top layer, enabling it to distinguish between lithography and etch problems and quantify the EUV local CDU problem using large-area statistical analysis. As is known, the EUV stochastic problem is becoming increasingly significant in high volume manufacturing and embodiments of the present disclosure may introduce the first, or one of the first, paths to ADI local CDU metrology. In other words, metrology of the sample at a point in time of after-develop (e.g., before etching the layers) may be used to more effectivity predict yield of samples and increase the process margin when fabricating samples.

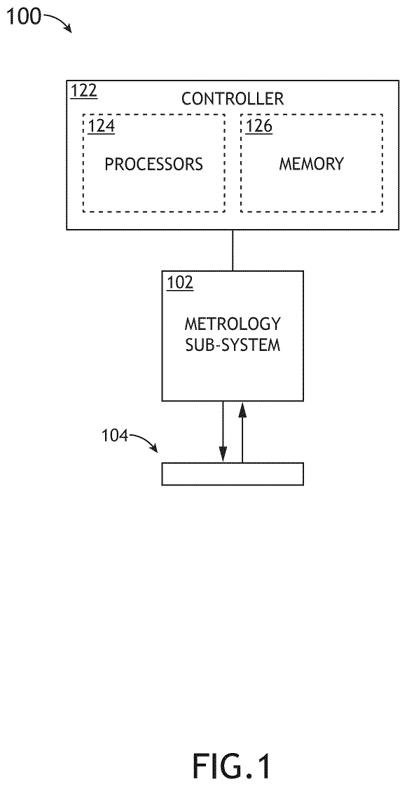

Referring to FIGS. 1 through 9, systems and methods for evaluating (and/or fabricating) a sample are disclosed, in accordance with one or more embodiments of the present disclosure.

FIG. 1 illustrates a block diagram of a system 100 for evaluating an error in fabrication of a sample 104, in accordance with one or more embodiments of the present disclosure. In embodiments, the system 100 includes a metrology sub-system 102 and a controller 122 communicatively coupled to the metrology sub-system 102.

The one or more metrology sub-systems 102 may include any metrology tool known in the art. In embodiments, the metrology sub-system 102 is configured to characterize properties such as, but not limited to, layer thickness, layer composition, critical dimension (CD), overlay, or lithographic processing parameters (e.g., intensity or dose of illumination during a lithographic step). In this regard, a metrology sub-system 102 may provide information about the fabrication of the sample 104 and/or one or more layers of the sample 104 that may be relevant to yield issues for the resulting fabricated devices. For purposes of the present disclosure, the metrology sub-system 102 may include a single metrology tool or may represent a group of metrology tools. For example, the metrology sub-system 102 may include an electron beam metrology tool. For instance, the metrology sub-system 102 may include a scanning electron microscope (SEM) tool configured to image features of a sample 104.

The controller 122 may include one or more processors 124. The one or more processors 124 may be configured to execute program instructions stored in memory 126 causing the one or more processors 124 to perform various steps of the present disclosure. For example, the controller 122 may be configured to receive or acquire an image of the sample 104 from the metrology sub-system 102 and analyze the image according to the program instructions. For instance, the controller may be configured to analyze an image of features of a sample 104.

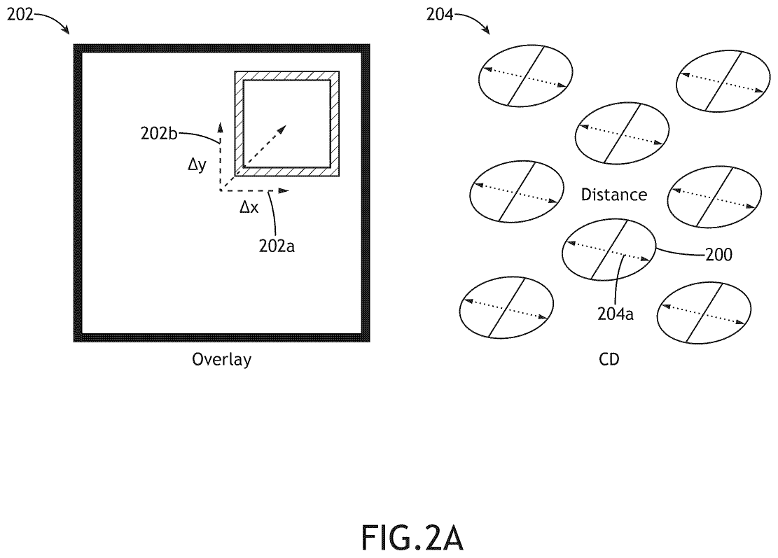

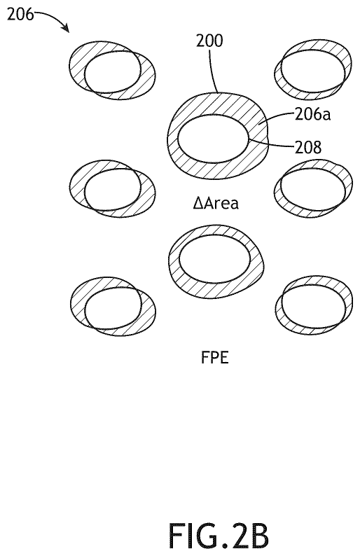

FIG. 2A illustrates a diagram of overlay 202 error and critical dimension (CD) error 204.

During the fabrication of the sample 104, one or more features 200 or patterns of features 200 may be incorporated onto the sample 104. The features 200 may be the actual, real-world shapes fabricated onto the sample 104. The features 200 may correspond to design shapes 208. The design shapes 208 may be used during the fabrication process as a template of the features 200.

In embodiments, the fabrication of the sample 104 may result in errors associated with the features 200 integrated onto the sample 104. For example, the features 200 may not directly reflect the design shapes 208 used during fabrication. For instance, the fabrication process may result in a feature 200 being offset/shifted from the designated location (e.g., overlay error). In another instance, the fabrication process may result in the integrated feature 200 being misshaped (e.g., an error of a critical dimension).

Overlay 202 may represent the offset/shift error in the placement of a feature 200 or patterns of features 200 on a sample 104. For example, an offset/shift error in the placement of a feature 200 may result in overlay 202 that may be expressed with reference to the direction the offset/shift has occurred, such as a vector comprising information about an X-direction overlay 202a and a Y-direction overlay 202b.

CD error 204 may represent a variation of a CD of the feature 200. The CD of a feature may include the size of a feature, the shape of a feature, the thickness of the feature, or the like. For example, the width 204a of a feature 200 may be a CD. In this instance, a CD error 204 may have occurred when the width 204a of a feature 200 is not within the threshold of the determined CD for the width of the feature 200.

Existing systems may measure overlay 202 and CD errors 204 to calculate edge placement error (EPE) as a metric to evaluate the fabrication process. EPE is used to curtail the electrical circuit resistance of a cell based on a measurement of overlay and CD. However, EPE is typically only evaluated from the lithography perspective. In this way, monitoring and optimizing EPE during the fabrication of samples does not necessarily provide a comprehensive indication of the extent of improvement in actual electrical characteristics. In other words, EPE does not necessarily predict electrical functionality of a completed device. Further, overlay and CD are typically only one-dimensional distances, resulting in EPE only representing a one-dimensional measurement. To overcome these shortfalls, feature placement error (FPE) may be used to gain a more comprehensive evaluation of the fabrication process and the functionality of the completed device.

FIG. 2B illustrates a diagram of FPE measurement 206, in accordance with one or more embodiments of the present disclosure. FPE measurement 206 may be used to characterize a difference between actual, real-world measured shapes of the features 200 of the sample 104 and design shapes 208. For example, the FPE measurement 206 may be performed by taking the difference between the design shapes 208 and a feature 200. For instance, the difference between the design shapes 208 and a feature 200 may define an area where the design shape 208 does not overlap the feature 200, herein referred to as an area of nonoverlap 206a. The calculated area of the nonoverlap 206a may correspond to the FPE measurement 206. In this regard, the FPE measurement 206 represents a two-dimensional measurement or is derived therefrom.

The FPE measurement 206 may be considered to account for a variety of potential characteristics of the features, including overlay 202 error, CD size (e.g., CD width 204a), CD shape, local critical dimension uniformity (LCDU), linewidth roughness (LWR), or the like. In this regard, FPE measurement 206 is more representative of the characteristics of the features 200 when compared to traditional EPE methods.

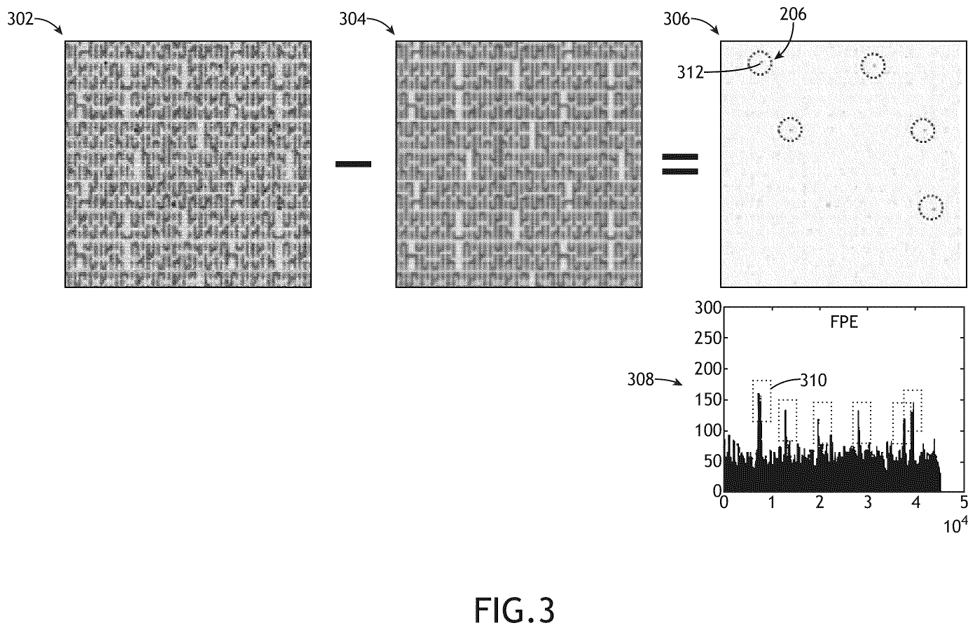

FIG. 3 illustrates a simplified diagram for performing FPE measurement 206, in accordance with one or more embodiments of the present disclosure.

The shapes of the features 200 of the sample 104 may be evaluated by processing an image 302 of the sample 104. For example, the metrology sub-system 102 may capture an image 302 of the features 200 of a sample 104. In this regard, the features 200 captured in the image 302 may be compared to the design shapes 208.

The design shapes 208 may reflect sample design data 304. The sample design data 304 may include sample design data images which correspond to a real-world sample 104. For example, the sample design data 304 may include geometric shapes (e.g., design shapes 208). For instance, the shapes may be represented in any way, such as polygon data, pixels, vectors, geometric formulas, and/or the like. In this regard, the shapes (e.g., design shapes 208) represented in the sample design data images may correspond to the features 200 of the sample 104. As an example, a mask used to manufacture the sample 104 may be based on the sample design data 304.

In embodiments, the sample design data 304 may include GDS data. For example, the sample design data 304 may include polygons, an image including pixels, geometric formulas of shapes to be manufactured, and/or the like. For instance, polygon data may be mathematically-defined boundaries (e.g., coordinates along a perimeter) of a polygon shape.

The sample design data 304 may be compared to the image 302 of the sample 104 to measure FPE. For example, the design shapes 208 indicated by the sample design data 304 may be compared to the actual features 200 captured in the image. When comparing the design shapes 208 to the features 200, areas may be found where the features 200 deviate from the design shapes 208, creating areas of nonoverlap 206a. In this regard, the design shapes 208 may subtracted or removed from features 200 to indicate areas of nonoverlap 206a for the entire image 302. The resulting subtracted image 306 may reflect the FPE measurements 206 (e.g., the calculated area of the areas of nonoverlap 206a) along the sample 104.

The subtracted image 306 may be used to monitor the fabrication process. For example, concentrations of peak 312 areas of nonoverlap may be monitored. For instance, peaks 312 may be configured to be monitored as a key performance indicator (KPI). Further data analysis may be conducted on the subtracted image to create an easier to understand metric. For example, a histogram chart 308 of peaks 310 may be used the visualize the peaks 312 in the subtracted image 306.

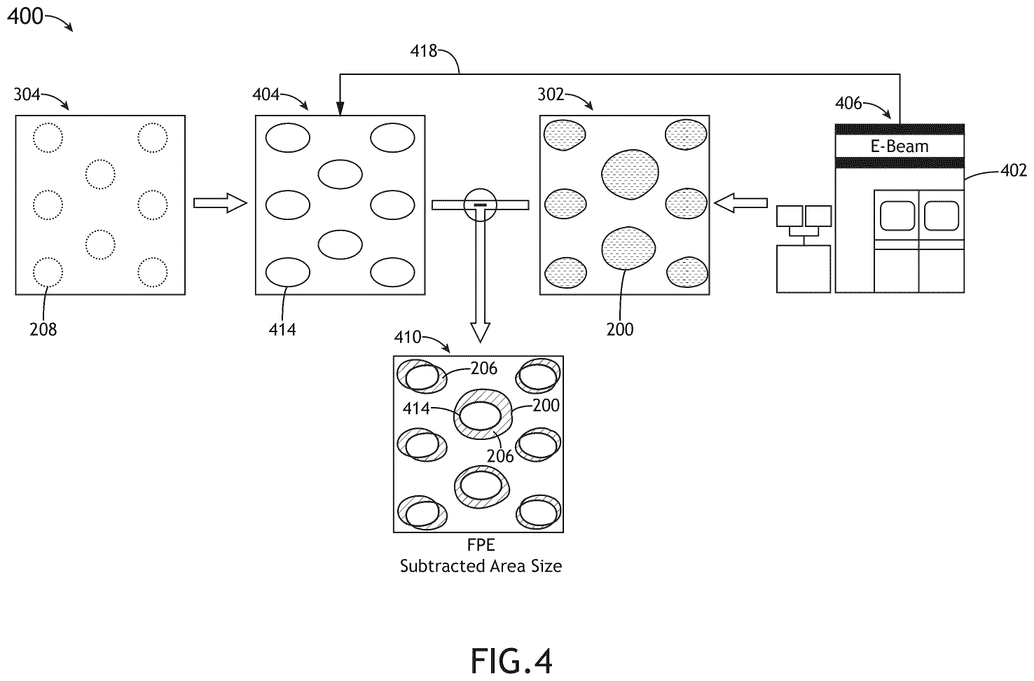

FIG. 4 illustrates a diagram for performing a FPE measurement, including a metrology calibration parameter.

In embodiments, the sample design data 304 may be modified, such as rendered, to more accurately represent and predict actual, real-world, shapes of features 200. For example, the controller 122 may be configured to generate one or more rendered sample design data images 404. The rendered sample design data images 404 may modify the (initial) sample design data 304 to calibrate it to more accurately predict the features 200 being manufactured. The rendered sample design data images 404 may include rendered design data shapes 414. For instance, the rendered sample design data images 404 may be based on the sample design data 304 and a metrology calibration parameter 418.

The metrology calibration parameter 418 may be determined based on images 302 received via the metrology sub-system 102 (e.g., an electron beam metrology tool). For example, the metrology calibration parameter 418 may be based on actual sizes, shapes, and/or the like of the actual manufactured features 200 in the images 302. For instance, if the average width of a specific type of features was 1.01 nanometers compared to an expected value of 1.00 nanometers, then the metrology calibration parameter 418 may be calculated as that difference. The metrology calibration parameter 418 may be expressed as +1%. This is a simplified example for illustrative purposes, and the metrology calibration parameter 418 may include any number of calibration adjustments configured to modify sample design data 304, such as modifying the design shapes 208. For instance, the metrology calibration parameter 418 may be configured to modify algorithms or the like configured to generate and determine widths, lengths, corner radii, locations, and/or the like of features in the rendered sample design data. The metrology calibration parameter 418 may also be based on known metrology errors due to the limitations of the metrology sub-system 102. By modifying the sample design data 304 to consider the metrology errors, the metrology errors may be effectively removed from the FPE measurement 206.

The FPE measurement 206 may be performed using the rendered sample design data images 404 in the same manner disclosed above. For example, the image 302 and the rendered sample design data image 404 may be used to determine the areas of nonoverlap 206a between shapes of the features 200 in the one or more images 302 and the rendered design data shapes 414 in the rendered sample design data image 404. The resulting FPE measurement 206 may provide a more meaningful metric than a FPE measurement performed with the (initial) sample design data 304. For example, using the rendered sample design data image 404 includes considerations about the real-life application of the sample design data, meaning the FPE measurements 206 reflect meaningful deviations of the features 200 rather than processing limitations.

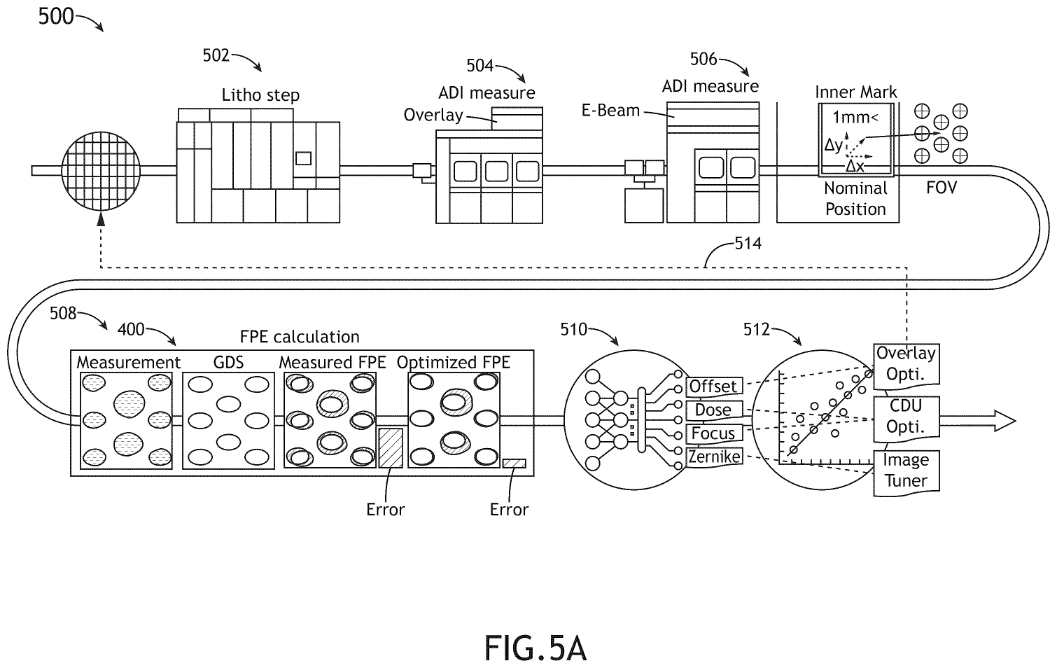

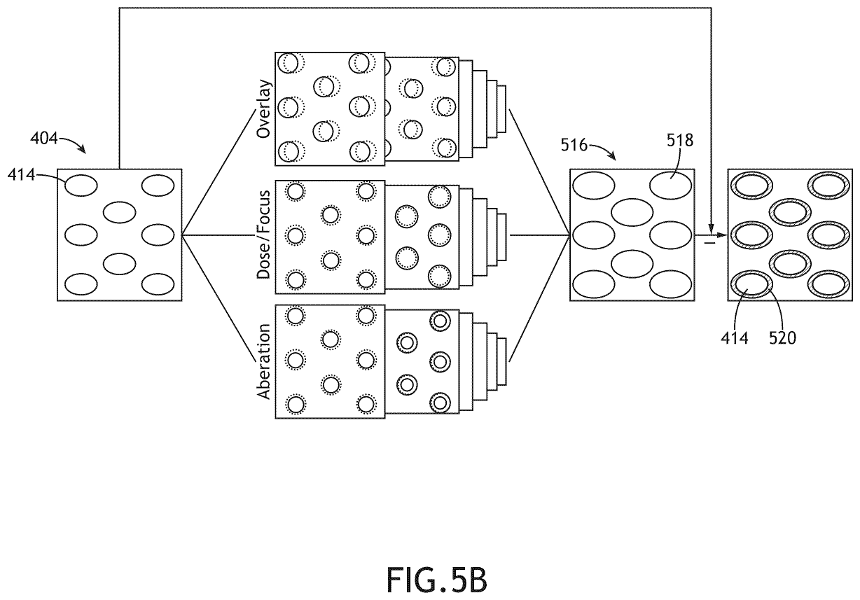

FIG. 5A illustrates a flow diagram 500 for performing FPE measurements in a fabrication system, in accordance with one or more embodiments of the present disclosure.

At a step 502, a lithography tool processes a sample 104. The lithography tool may fabricate features 200 onto the sample 104. For example, the lithography tool may use a mask to fabricate the features 200.

At a step 504, the sample 104 may be processed by a metrology sub-system 102 at ADI. The metrology sub-system 102 may measure a variety of parameters from the sample 104 as described above. For example, the metrology sub-system 102 may include one or more metrology tools configured for measuring overlay 202 of the sample 104.

At a step 506, one or more images 302 may be captured of the sample 104. For example, an electron tool (e.g., SEM tool) may be used to image the sample 104.

At a step 508, the FPE measurements may be performed, such as using process flow 400 described in FIG. 4. The FPE measurements may be further processed to measure an optimized FPE. In this regard, the FPE measurements may be adjusted or optimized to indicate parameters such as X-direction placement shift, Y-direction placement shift, focus, light source dose, aberration correction, or critical dimension size, or the like. For example, a simulation may be utilized to simulate one or more parameter adjustments and the effects the parameter adjustments may have on an actual sample by modifying the design data (e.g., sample design data 304 or rendered sample design data). For instance, data to database (D:DB) technology may be used to replicate the parameter adjustments on the sample design data 304 and/or the rendered sample design data into an adjusted design data image 516 by applying the simulated adjustments to the sample design data 304 and/or the rendered sample design data. The simulation may continue making simulated adjustments, until the difference between the adjusted sample design data image 516 and the image 302 of the sample 104 is as minimal as possible within the bounds of parameters available for simulated adjustments. The resulting difference may define the optimized FPE measurements. In this regard, the optimized FPE measurement considers what parameters may have occurred in order to result in the features 200 from the sample 104.

FIG. 5B illustrates a flow diagram for performing simulated FPE measurements. The simulation may determine an approximate FPE measurements from one or more simulated FPE measurements 520 to evaluate the adjusted sample design data image 516 against the actual features 200 of the sample 104. The simulated FPE measurements 520 may be theoretical FPE values based on the adjusted design data image 516 resulting from the simulated adjustments to parameters (e.g., X-direction placement shift, Y-direction placement shift, focus, light source dose, aberration correction, or critical dimension size). For example, the simulation may adjust the design data (e.g., sample design data 304 or rendered sample design data) to reflect one or more parameter changes (e.g., the design shapes 208 are adjusted). The difference between the (initial) design shapes (e.g., design shapes 208 or rendered design shapes 414) and the adjusted design data shapes 518 may be measured by calculating the area of nonoverlap, generating simulated FPE measurements 520 for the adjusted design data image 516. The simulation may be performed iteratively, generating many simulated FPE measurements 520, until the difference between the simulated FPE measurements 520 associated with an adjusted sample design data image 516 and the actual FPE measurements is minimized according to a cost function.

For instance, a cost function may be of the form:

$$cost function = \frac{1}{n} {\sum }_{i = 1}^{n} {( {F}_{i} - {\hat{F}}_{i} )}^{2}$$

where n is the total number of data points or measurements (e.g., the total number of FPE measurements for an image) being considered in the cost function, Fᵢ is the actual FPE measurement for the i-th data point, \hat{F}ᵢ is the simulated or theoretical FPE value for the i-th data point, and (Fᵢ−\hat{F}ᵢ)² represents the squared difference between the actual and simulated FPE values for each data point, providing a measure of the overall error or cost. In this regard, the cost function may be used to determine which adjusted sample design data image 516 resulted in simulated FPE measurements 520 closest to the actual FPE measurements performed on the image 302, herein referred to as an approximate FPE measurement.

The adjusted design data image 516 associated with the approximate FPE may be used to perform an optimal FPE measurement by overlapping the adjusted design data image 516 from the image 302 of the features 200 of the sample 104. For example, the adjusted design shapes 518, having been adjusted based upon the simulated adjustments, may be subtracted from features 200, resulting in an optimal FPE measurement. The optimal FPE measurement may represent the overall minimum FPE that may be obtained based on the range of parameters that simulated adjustment may be made from.

At steps 510, the adjusted FPE measurements may be used to determine modifications to make to the fabrication of the sample 104.

For example, the adjustments (e.g., simulated adjustments) to parameters (e.g., direction offset, Y-direction offset, dose, focus, Zernike aberration values, critical dimension size) corresponding to an optimal FPE measurement may be analyzed to determine FPE correctables. FPE correctables may include adjustments to parameters or values derived thereof. The FPE correctables may be used in a feed-back loop or feed-forward loops to improve yields of fabricated samples 104. The optimal FPE measurements may be analyzed in any number of ways to determine FPE correctables. For example, at step 512, the analysis may include a regression analysis configured to optimize the parameters. For instance, the controller 122 may be configured to transmit data 514 in a feed-forward or feed-back loop to a fabrication tool. For instance, as shown, FPE correctables may be used in a feed-back loop at ADI. For instance, X-direction offset parameters may be transmitted in a feed-back loop to a fabrication tool to re-fabricate the current layer in a slightly different shifted position to improve electrical connectivity and yield of the sample 104. In this regard, the FPE correctables may result in improved yields of samples 104.

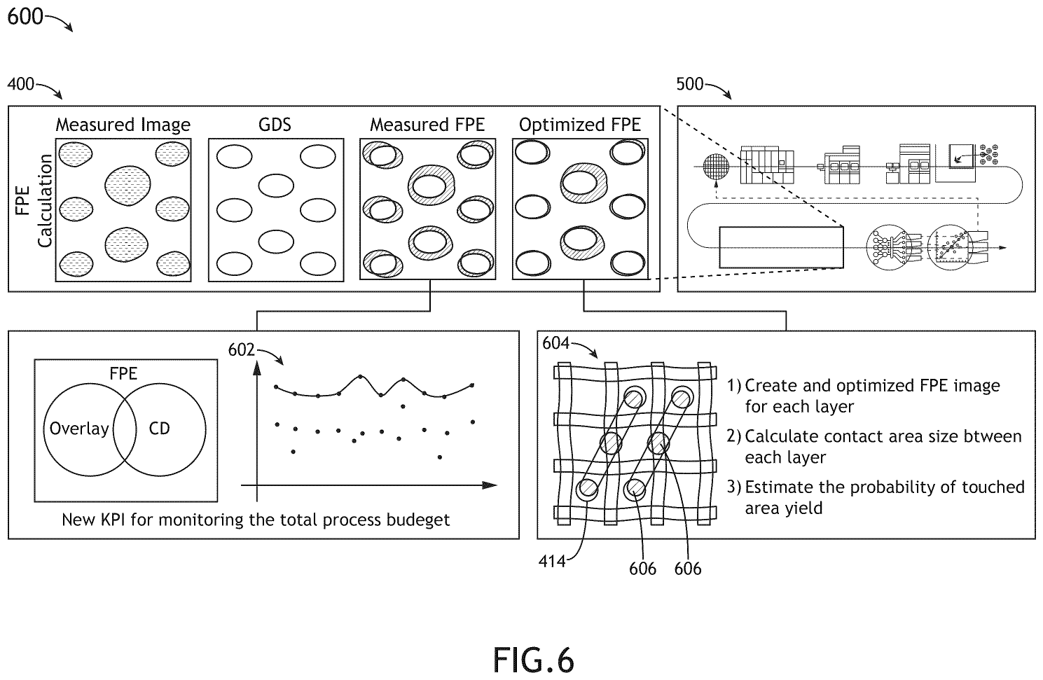

FIG. 6 illustrates a flow diagram 600 for monitoring a process budget using FPE measurements, in accordance with one or more embodiments of the present disclosure.

The FPE measurements performed as described herein may be utilized as a monitoring metric for mass production (e.g., mass lithographic processes). Different FPE measurements (e.g., rendered FPE measurements or adjusted FPE measurements) may provide a variety of production information such as KPIs, yields, or the like.

For example, at step 602, the FPE measurements are monitored over time. For instance, one or more controllers 122 may monitor a plurality of FPE measurements over time. The one or more controllers 122 may be configured to transmit a monitoring signal based on the plurality of FPE measurements breaching a FPE threshold. For example, if the FPE measurements get too high, a monitoring signal may be transmitted and configured to be displayed on a user interface (e.g., monitor display of a computer or the like). The monitoring signal may include a graphical and/or textual alert. In this regard, the FPE measurements acquired for each layer of the sample 104 can serve as a new KPI for quality monitoring in mass production.

The optimal FPE measurements may be used for yield prediction. For example, at step 604, optimal FPE measurements may be used to determine an estimated yield. For example, one or more optimal FPE images based on the simulated adjustments to parameters may be generated for each layer of a sample 104, according to the parameters. Contact areas 606 between layers (e.g., adjacent layers) may be determined from the adjusted FPE images. For example, the contact areas 606 may be overlapping areas of shapes in adjacent layers of the optimized FPE images. Next, a probability of touching/overlapping area yield may be determined based on the size of contact areas 606. For example, a higher size/area may correspond to a higher probability of yield. In this regard, the yield of samples 104 may be predicted by analyzing multiple (simulated) layers of the sample based on optimized FPE measurements.

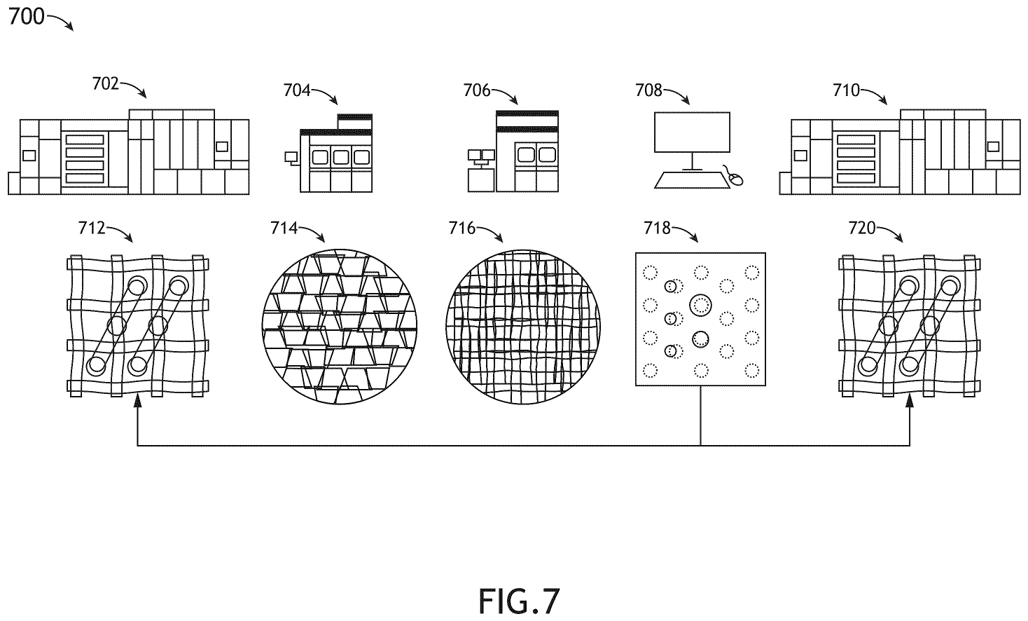

FIG. 7 illustrates a flow diagram 700 for determining a KPI, in accordance with one or more embodiments of the present disclosure.

In embodiments, a measurement and then correctables may be determined to correct for overlay, dose/focus, and aberration. For the measurement, area placement error may be derived based on (rendered/simulated) sample design data at both ADI and after-clean inspection (ACI). Next, for the correctables, optimized contact area may be determined for 1) APC overlay, 2) dose and focus, and 3) aberration.

At step 704, an overlay grid 714 and an anchor point may be determined based on measured sample 104.

At step 706, an upscaled image 716 may be determined based on a (new) FPE KPI upscaling factor determined based on the anchor point using sparse to dense scaling and dot to area conversion.

At step 708, an adjusted FPE measurement and a corresponding optimized image 718 with features having shapes may be determined. For example, the optimized image 718 may be determined based on a typical data-to-database (D:DB) methodology. For instance, the optimized FPE measurement may be determined based on a cost function configured to minimize FPE as a function (F) of F(x offset, y offset, focus, dose, aberration).

At step 702, lithography may be performed on the next lot of samples 104 based on a signal transmitted to a fabrication tool (e.g., lithography tool).

At step 710, lithography may be performed on the next layer of the (current) sample 104 based on a signal transmitted to a fabrication tool 106 (e.g., lithography tool). The signal may be based on the optimized FPE measurement. For example, the signal may include the values of the parameters of the function F(x offset, y offset, focus, dose, aberration). In this way, the signal may include correctables. For example, the signal may be a feed forward signal. In addition, or alternatively, the signal may be a feedback signal. In embodiments, the signal may be used to optimize for overlapping layer areas (i.e., contact areas) for 1) APC overlay, 2) dose and focus, and 3) aberration.

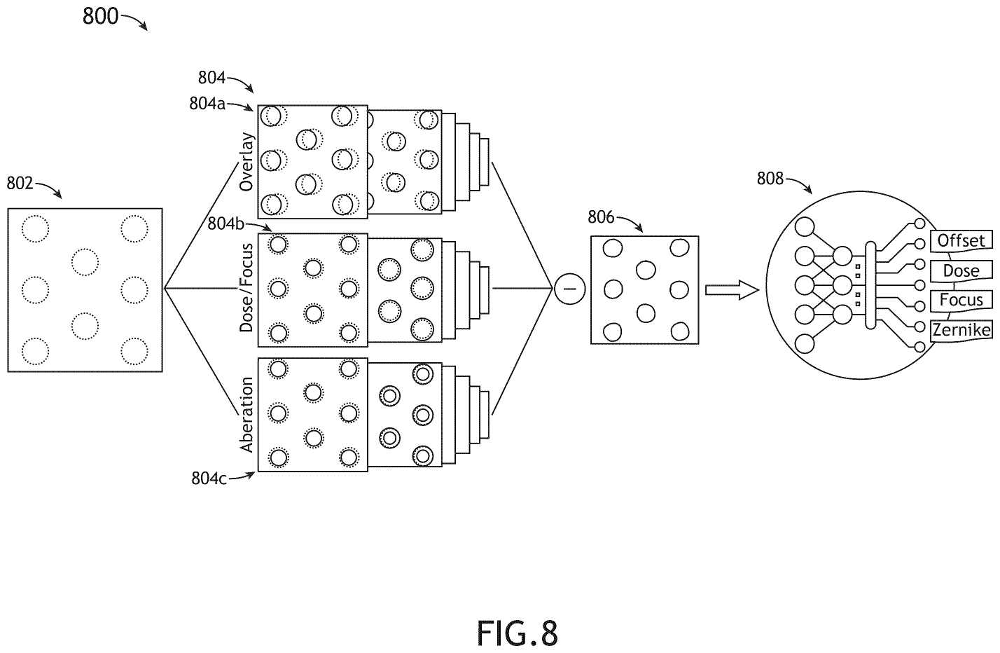

The system 100 described herein may be configured to use lithography simulation, rather than real measurement. Lithography simulation may permit machine learning (ML) training, or the like, to obtain images of features in situations when real measurement is difficult or inaccessible. For example, lithography simulation may provide ML training with a sufficient amount of training data more quickly than the actual measurement of production sample. FIG. 8 illustrates a flow diagram 800 for generating simulated FPEs in a lithography simulation, in accordance with one or more embodiments of the present disclosure.

The controller 122 may be configured to determine one or more simulated FPE measurements based on simulated adjustments to at least one of: X-direction placement shift, Y-direction placement shift, focus, light source dose, aberration correction, or critical dimension size.

In embodiments, one or more parameters may be adjusted to generate simulated images 804. For example, simulated overlay adjustments configured to shift the features in the X and/or Y direction may be used to generate simulated images 804a. By way of another example, at least one of dose adjustments or focus adjustments may be used to generate simulated images 804b. Dose adjustments may be adjustments made to the timing or intensity of source light used in fabrication of the samples 104. Focus adjustments may include moving a focus plane relative to a vertical direction of the sample and/or adjusting focus of an optical lens of the fabrication tool. By way of another example, simulated adjustments to aberration may be used to generate simulated images 804c. For instance, a simulation of changing or swapping out of aberration correction components (e.g., Zernike correction lens) may be performed.

The simulated images 804 may be compared to a reference image 806. For example, the shapes in the simulated images 804 may be subtracted from shapes in the reference image 806 to measure simulated FPE. The simulated FPE measurement and the associated simulated adjustments made while generating the simulated images may be used as training data in a ML system 808.

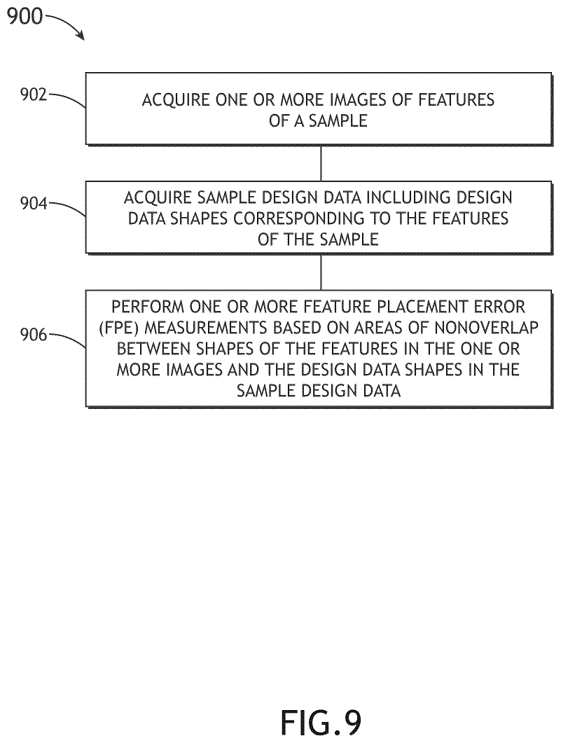

FIG. 9 illustrates a process flow diagram depicting a method 900, in accordance with one or more embodiments of the present disclosure. It is noted that the embodiments and enabling technologies described previously herein in the context of the system 100 should be interpreted to extend to the method 900. It is further noted herein that the steps of method 900 may be implemented all or in part by system 100. It is further recognized, however, that the method 900 is not limited to the system 100 in that additional or alternative system-level embodiments may carry out all or part of the steps of method 900.

At step 902, one or more images 302 of features 200 of a sample 104 are acquired. For example, controller 122 may be configured to acquire the images 302. For instance, program instructions stored on memory 126 may be configured to acquire the images 302, such as receiving the images 302 from a metrology sub-system 102. For instance, the metrology sub-system 102 may be configured to acquire the images and transmit the images to the controller 122. For instance, the metrology sub-system 102 may be an SEM tool. An example of an image is shown by image 302 of FIG. 3 and image 408 of FIG. 4.

At step 904, sample design data 304 corresponding to the features 200 of the sample 104 are acquired. For example, the sample design data 304 may include GDS data. For instance, the sample design data 304 may be polygons, an image including pixels, geometric formulas of shapes to be manufactured, and/or the like. For instance, a mask used to manufacture the sample 104 may be based on the sample design data. As noted earlier, the sample design data 304 may itself be original data and/or may be modified, such as being modified based on metrology calibration parameters 418 of FIG. 4. An example of modified/rendered/simulated sample design data is shown by the rendered sample design data image 404 of FIG. 4.

At step 906, one or more FPE measurements 206 are performed based on calculated areas of nonoverlap between shapes of the features 200 in the one or more images 302 and design shapes in the sample design data 304. For example, controller 122 may be configured to determine the FPE measurements 206. For example, consider two overlapping shapes, one shape (e.g., rendered design data shapes 414) from the sample design data and another shape being the actual feature 200 imaged by a metrology sub-system 102. The calculated areas of nonoverlap may be the areas where the design data shapes (rendered design data shapes 414) and features 200 do not overlap each other.

Referring again to FIG. 1, various components are described in greater detail in accordance with one or more embodiments of the present disclosure.

The one or more processors 124 of the controller 122 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 124 may include any device configured to execute algorithms and/or instructions (e.g., program instructions stored in memory). In embodiments, the one or more processors 124 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of the system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 122 may include one or more controllers housed in a common housing or within multiple housings. In this way, any controller or combination of controllers may be separately packaged as a module suitable for integration into system 100. Further, the controller 122 may analyze or otherwise process data received from one or more sensors and feed the data to additional components within the system 100 or external to the system 100.

Further, the memory 126 may include any storage medium known in the art suitable for storing program instructions executable by the associated one or more processors 124. For example, the memory 126 may include a non-transitory memory medium. As an additional example, the memory 126 may include, but is not limited to, a read-only memory, a random-access memory, a magnetic or optical memory device (e.g., disk), a magnetic tape, a solid-state drive and the like. It is further noted that memory 126 may be housed in a common controller housing with the one or more processors 124.

In this regard, the controller 122 may execute any of various processing steps associated with metrology. For example, the controller 122 may be configured to generate control signals to direct or otherwise control the metrology sub-system 102, or any components thereof. For instance, the controller 122 may be configured to receive signals corresponding to the images from the metrology sub-system 102. By way of another example, the controller 122 may generate correctables for one or more additional fabrication tools as feedback and/or feed-forward control of the one or more additional fabrication tools based on FPE measurements from the metrology sub-system 102.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently, “temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

We claim:

1. A system comprising:
a controller comprising one or more processors configured to execute program instructions, wherein the program instructions are configured to cause the one or more processors to:
acquire one or more images of features of a sample from a metrology sub-system;
acquire sample design data comprising design data shapes corresponding to the features of the sample; and
perform one or more feature placement error (FPE) measurements based on areas of nonoverlap between shapes of the features in the one or more images and the design data shapes in the sample design data.

2. The system of claim 1, wherein the controller is further configured to:
perform one or more simulated FPE measurements based on simulated adjustments to at least one of: X-direction offset, Y-direction offset, focus, light source dose, aberration correction, or critical dimension size.

3. The system of claim 2, wherein the controller is further configured to:
determine one or more approximate FPE measurements from the one or more simulated FPE measurements based on a cost function.

4. The system of claim 3, wherein the controller is further configured to:
determine one or more approximate FPE measurements from the one or more simulated FPE measurements based on minimizing a difference between the one or more simulated FPE measurements and the one or more FPE measurements.

5. The system of claim 3, wherein the controller is further configured to:
perform one or more optimal FPE measurements based on areas of nonoverlap between the shapes of the features and adjusted design data shapes from one or more adjusted design data images, wherein the one or more adjusted design data images is generated by applying the simulated adjustments associated with the one or more approximate FPE measurements to the sample design data.

6. The system of claim 5, wherein the controller is further configured to:
transmit data in at least one of a feed-forward or feedback loop to a fabrication tool based on the one or more optimal FPE measurements.

7. The system of claim 1, wherein at least one of the one or more images of the features of the sample is configured to be acquired at after-develop inspection (ADI).

8. The system of claim 1, wherein at least one of the one or more images of the features of the sample is configured to be acquired at after-clean inspection (ACI).

9. The system of claim 1, wherein the controller is further configured to:
render the sample design data based on metrology calibration parameters determined from the one or more images to generate rendered sample design data.

10. The system of claim 1, wherein the sample design data comprises polygon data associated with the features.

11. A system comprising:
a metrology sub-system; and
a controller communicatively coupled to the metrology sub-system and comprising one or more processors configured to execute program instructions causing the one or more processors to:
acquire one or more images of features of a sample;
acquire sample design data comprising design data shapes corresponding to the features of the sample; and
perform one or more feature placement error (FPE) measurements based on areas of nonoverlap between shapes of the features in the one or more images and the design data shapes in the sample design data.

12. The system of claim 11, wherein the metrology sub-system comprises an electron beam metrology tool.

13. A method comprising:
acquiring one or more images of features of a sample;
acquire sample design data comprising design data shapes corresponding to the features of the sample; and
perform one or more feature placement error (FPE) measurements based on areas of nonoverlap between shapes of the features in the one or more images and the design data shapes in the sample design data.

14. The method of claim 13, further comprising:
performing one or more simulated FPE measurements based on simulated adjustments to at least one of: X-direction offset, Y-direction offset, focus, light source dose, aberration correction, or critical dimension size.

15. The method of claim 14, further comprising:
performing one or more adjusted FPE measurements based on the one or more simulated FPE measurements and a cost function.

16. The method of claim 15, further comprising:
transmitting data in a feed forward or feedback loop to a fabrication tool based on the one or more adjusted FPE measurements.

17. The method of claim 13, wherein at least one of the one or more images of the features of the sample is configured to be acquired at after-develop inspection (ADI).

18. The method of claim 13, wherein at least one of the one or more images of the features of the sample is configured to be acquired at after-clean inspection (ACI).

19. The method of claim 13, further comprising:
determining the sample design data based on metrology calibration parameters determined based on the one or more images.

20. The method of claim 13, wherein acquiring the one or more images is performed via a metrology sub-system comprising an electron beam metrology tool.

21. The method of claim 13, wherein the sample design data comprises polygon data of the features.
